(19) United States
(12) Patent Application Publication
(10) Pub. No.: US 2018/0310010 A1
(43) Pub. Date: Oct. 25, 2018

(54) METHOD AND APPARATUS FOR DELIVERY OF STREAMED PANORAMIC IMAGES

(71) Applicant: Nokia Technologies Oy, Espoo (FI)

(72) Inventors: Ari HOURUNRANTA, Tampere (FI); Maneli NOORKAMI, Menlo Park, CA (US); Devon COPLEY, San Francisco, CA (US)

(21) Appl. No.: 15/945,889

(22) Filed: Apr. 5, 2018

Related U.S. Application Data
(60) Provisional application No. 62/487,840, filed on Apr. 20, 2017.

(51) Int. Cl. H04N 19/34; H04N 13/161; H04N 19/44; H04N 19/162; H04N 19/187; H04N 19/115

(52) U.S. Cl. CPC H04N 19/34; H04N 13/161; H04N 19/115; H04N 19/162; H04N 19/187; H04N 19/44

(57) ABSTRACT

A method, apparatus and computer program product are provided for the efficient streaming and processing of high-resolution panoramic video images, such as 360° panoramic video. In some implementations of example embodiments, a base layer video image set may be transmitted to and received by a viewer, and used to provide visual content at a relatively low resolution and/or bitrate in order to reduce the bandwidth requirements and/or other processing resources necessary to stream and render the video. For the portions of an image associated with a viewport of a user, one or more tiles at a higher resolution may be provided in an enhancement layer that may be merged with the base layer to provide higher resolution content in the viewer's field of view.

### CROSS REFERENCE TO RELATED APPLICATION

This application claims the benefit of U.S. Provisional Patent Application Ser. No. 62/487,840, which was filed on Apr. 20, 2017 and entitled “Method and Apparatus For View Dependent Delivery of Streamed Panoramic Images”.

### TECHNICAL FIELD

An example embodiment relates generally to image processing technology. Some example implementations are directed to systems, methods, and apparatuses for the streaming panoramic images.

### BACKGROUND

Video images featuring 360° and other panoramic views has grown in popularity as viewers of visual media have continued to seek improved media experiences. The streaming of 360° video content and other content featuring panoramic views has become especially popular in contexts where the viewer seeks an immersive viewing experience, such as those available from virtual reality systems, systems that use a head-mounted display, and other systems configured to present content across a wider field of view than that offered by conventional image viewing systems.

As the popularity of immersive video content has increased, many viewers have come to expect to be able to readily stream high quality, high resolution content using a wide range of mobile, networked devices.

### BRIEF SUMMARY

In an example embodiment, a method is provided that includes receiving a base layer video image set, wherein the base layer video image set is associated with a first resolution and a first bitrate; receiving a first enhancement layer video image set, wherein the first enhancement layer video image set is associated with a second resolution and a second bit rate, and wherein the first enhancement layer video image set comprises a plurality of image tiles associated with a viewport of a user; decoding a set of image tiles from within the plurality of image tiles to form a plurality of decoded image tiles; merging the decoded image tiles; and causing the base layer video image set and the merged decoded image tiles to be displayed to a viewer. In some example implementations of such a method, the base layer video image set is a 360° equirectangular base layer video.

In some such example implementations, and in other example implementations, the base layer video image set is independent of the plurality of image tiles. In some such example implementations, and in other example implementations the second resolution is higher than the first resolution. In some such example implementations, and in other example implementations the second bitrate is higher than the first bitrate. In some such example implementations, and in other example implementations two or more image tiles within the plurality of image tiles are substantially the same shape.

In some such example implementations, and in other example implementations, an image tile within the plurality of image tiles is configured to be used in an equirectangular projection. In some such example implementations, and in other example implementations, an image tile within the plurality of image tiles is configured to be used in a Lambert projection. In some such example implementations, and in other example implementations, an image tile within the plurality of image tiles is configured to be used in a cubemap projection.

In some such example implementations, and in other example implementations causing the base layer video image set and the merged decoded image tiles to be displayed to a viewer comprises causing the base layer video image set and the merged decoded image tiles to be displayed on a mobile device associated with user. In some such example implementations, and in other example implementations, the method further includes detecting a change in a viewport associated with a viewer and requesting a second enhancement layer video image set.

In another example embodiment, an apparatus is provided that includes at least one processor and at least one memory that includes computer program code with the at least one memory and the computer program code configured to, with the at least one processor, cause the apparatus to at least receive a base layer video image set, wherein the base layer video image set is associated with a first resolution and a first bitrate; receive a first enhancement layer video image set, wherein the first enhancement layer video image set is associated with a second resolution and a second bit rate, and wherein the first enhancement layer video image set comprises a plurality of image tiles associated with a viewport of a user; decode a set of image tiles from within the plurality of image tiles to form a plurality of decoded image tiles; merge the decoded image tiles; and cause the base layer video image set and the merged decoded image tiles to be displayed to a viewer. In some example implementations of such an apparatus, the base layer video image set is a 360° equirectangular base layer video.

In some such example implementations, and in other example implementations, the base layer video image set is independent of the plurality of image tiles. In some such example implementations, and in other example implementations, the second resolution is higher than the first resolution. In some such example implementations, and in other example implementations the second bitrate is higher than the first bitrate. In some such example implementations, and in other example implementations two or more image tiles within the plurality of image tiles are substantially the same shape.

In some such example implementations, and in other example implementations, an image tile within the plurality of image tiles is configured to be used in an equirectangular projection. In some such example implementations, and in other example implementations, an image tile within the plurality of image tiles is configured to be used in a Lambert projection. In some such example implementations, and in other example implementations, an image tile within the plurality of image tiles is configured to be used in a cubemap projection.

In some such example implementations, and in other example implementations causing the base layer video image set and the merged decoded image tiles to be displayed to a viewer comprises causing the base layer video image set and the merged decoded image tiles to be displayed on a mobile device associated with user. In some such example implementations, and in other example implementations, the computer program code is further configured to, with the processor, cause the apparatus to at least further detect a change in a viewport associated with a viewer and request a second enhancement layer video image set.

In a further example embodiment, a computer program product is provided that includes at least one non-transitory computer-readable storage medium having computer-executable program code instructions stored therein with the computer-executable program code instructions including program code instructions configured to receive a base layer video image set, wherein the base layer video image set is associated with a first resolution and a first bitrate; receive a first enhancement layer video image set, wherein the first enhancement layer video image set is associated with a second resolution and a second bit rate, and wherein the first enhancement layer video image set comprises a plurality of image tiles associated with a viewport of a user; decode a set of image tiles from within the plurality of image tiles to form a plurality of decoded image tiles; merge the decoded image tiles; and cause the base layer video image set and the merged decoded image tiles to be displayed to a viewer

In a further example embodiment, an apparatus is provided that includes means for at least receiving a base layer video image set, wherein the base layer video image set is associated with a first resolution and a first bitrate; means for receiving a first enhancement layer video image set, wherein the first enhancement layer video image set is associated with a second resolution and a second bit rate, and wherein the first enhancement layer video image set comprises a plurality of image tiles associated with a viewport of a user; means for decoding a set of image tiles from within the plurality of image tiles to form a plurality of decoded image tiles; means for merging the decoded image tiles; and means for causing the base layer video image set and the merged decoded image tiles to be displayed to a viewer. In a further embodiment, the apparatus also includes a means for detecting a change in a viewport associated with a viewer and requesting a second enhancement layer video image set.

### BRIEF DESCRIPTION OF THE DRAWINGS

Having thus described certain example embodiments, reference will hereinafter be made to the accompanying drawings, which are not necessarily drawn to scale, and wherein:

FIG. 1 depicts an example system environment in which implementations in accordance with an example embodiment of the present invention may be performed;

FIG. 2 is a block diagram of an apparatus that may be specifically configured in accordance with an example embodiment of the present invention;

FIG. 3 is a block diagram illustrating an example image projection that may be used in accordance with example embodiments of the present invention;

FIG. 4 depicts a graphical representation of an image projection that illustrates some of the concepts and technical issues addressed by embodiments of the present invention;

FIG. 5 a block diagram illustrating an example image projection that may be used in accordance with example embodiments of the present invention;

FIG. 6 is a flowchart illustrating the operations performed, such as by the apparatus of FIG. 2, in accordance with an example embodiment of the present invention;

FIG. 7 is a graphical representation of terms referenced in connection with describing some of the example embodiments contained herein;

FIG. 8 is another graphical representation of terms referenced in connection with describing some of the example embodiments contained herein; and

FIG. 9 is another graphical representation of terms referenced in connection with describing some of the example embodiments contained herein.

### DETAILED DESCRIPTION

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

As used herein, the term “viewport” or “VR viewport” refers to a subset of an omnidirectional field of view. The term “viewport” may refer to a subset of the omnidirectional visual content currently being displayed for a user and/or a subset of the omnidirectional visual content that is coded with distinction (such as quality distinction or as a separable part, or a motion-constrained tile set, for example) from the remaining visual content. A distinction between these two definitions may be provided through a qualifier; such that the former may be referred to as a rendered viewport while the latter may be referred to as a coded viewport. In some cases a viewport may be represented by an orientation and a field of view, while in some other cases a viewport may be represented by an area, such as a rectangle, within a two-dimensional coordinate system for a particular projection format. An example of the latter is a rectangle within an equirectangular panorama image. A viewport may comprise several constituent viewports, which jointly form the viewport and may have different properties, such as picture quality.

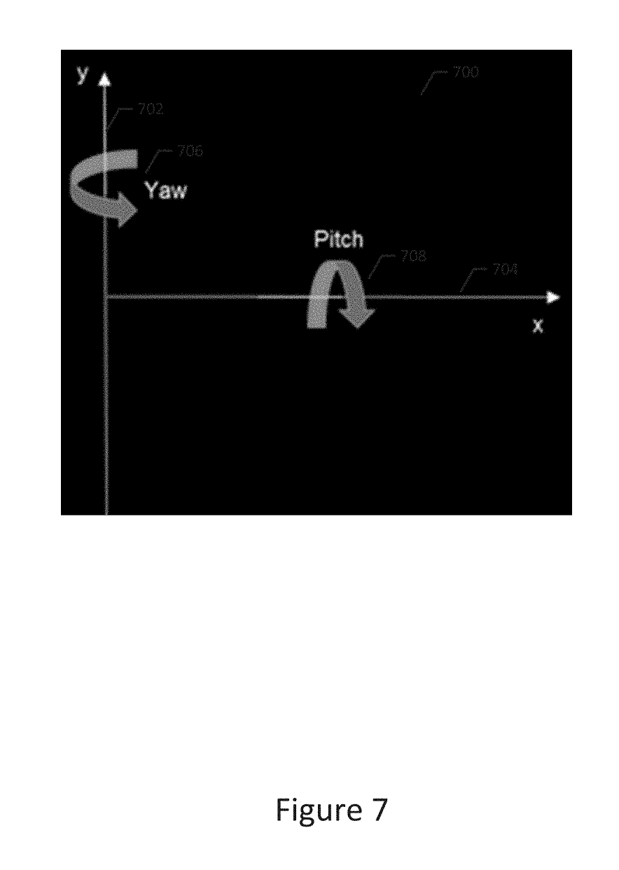

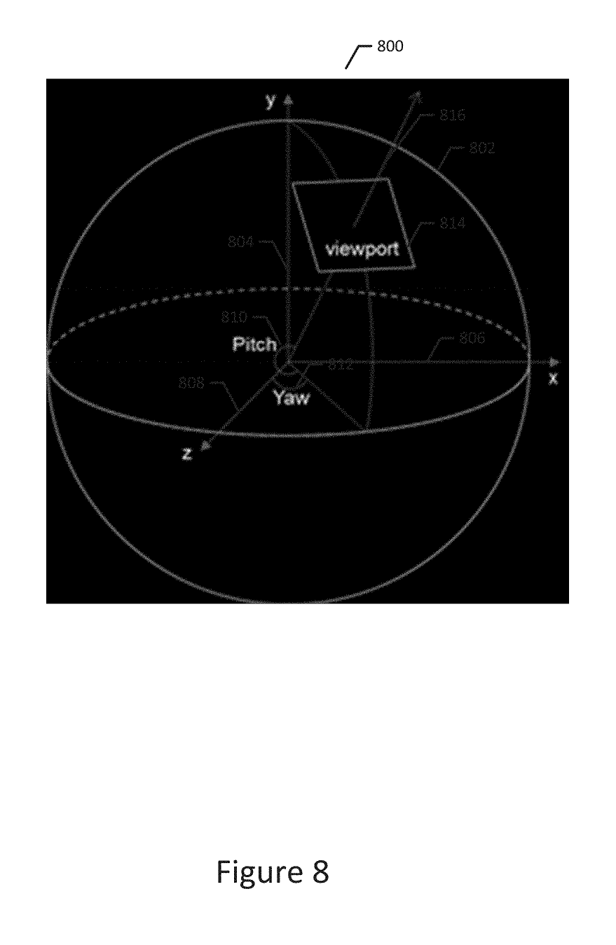

As used herein, an “orientation” (such as an orientation of a viewport, for example) may be represented by angular coordinates of a coordinate system. Angular coordinates may, for example, be called yaw, pitch, and roll, indicating the rotation angles around certain coordinate axes, such as y, x and z, respectively. Yaw, pitch, and roll may be used, for example, to indicate an orientation of a viewport. In some contexts, viewport orientation may be constrained; for example, roll may be constrained to be 0. In some such examples, and in other examples, yaw and pitch indicate the Euler angle of the center point of the viewport in degrees. In most contexts, yaw is applied prior to pitch, such that yaw rotates around the Y-axis, and pitch around the X-axis. Likewise, in most contexts, the angles increase clockwise as viewed when looking away from the origin. With reference to FIG. 7, axes 700 include a Y-axis 702 and an X-axis 704. As shown in FIG. 7, yaw 706 is depicted as a rotation around Y-axis 702, and pitch 708 is depicted as a rotation around X-axis 704. With reference to FIG. 8, axes 800 are used to map a three-dimensional space 802 via Y-axis 804, X-axis 806, and Z-axis 808. As shown in FIG. 8, pitch 810 and yaw 812 can be used to indicate the Euler angle of the center point of the viewport 814, which lies along vector 816.

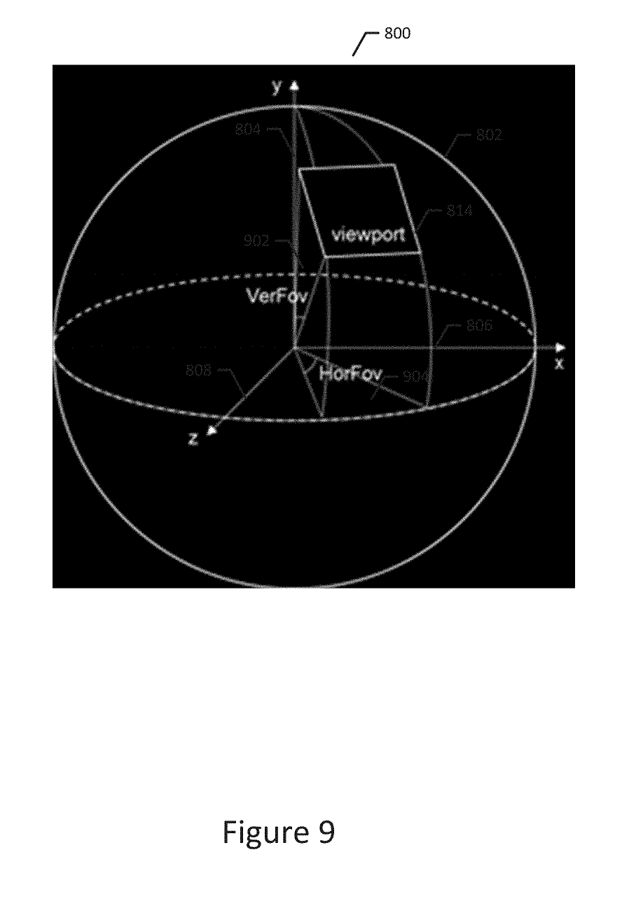

In some example implementations, a field of view (FOV) of a viewport may be represented by a horizontal FOV (HorFov) and a vertical FOV (VerFov). In some contexts HorFov and VerFov may be defined, for example, such that HorFov indicates the horizontal field of view of the viewport in degrees and VerFov indicates the vertical field of view of the viewport in degrees. An example depiction of the use of HorFov and VerFov to represent the FOV of a viewport is presented in FIG. 9. In FIG. 9, the same three dimensional space 802 from FIG. 8 is mapped with axes 800 (including Y-axis 804, X-axis 806, and Z-axis 808). Viewport 814 is likewise placed within space 802. Rather than using pitch and/or yaw to express the Euler angle of the center point of the viewport 814, FIG. 9 depicts an example in which it is possible to represent the field of view of the viewport 814 as HorFov 902 and a VerFov 904.

As used herein, the term “random access” may refer to the ability of a decoder to start decoding a stream at a point other than the beginning of the stream and recover an exact or approximate reconstructed media signal, such as a representation of the decoded pictures. A random access point and a recovery point may be used to characterize a random access operation. A random access point may be defined as a location in a media stream, such as an access unit or a coded picture within a video bitstream, where decoding can be initiated. A recovery point may be defined as a first location in a media stream or within the reconstructed signal characterized in that all media, such as decoded pictures, at or subsequent to a recovery point in output order are correct or approximately correct in content, when the decoding has started from the respective random access point. If the random access point is the same as the recovery point, the random access operation is instantaneous; otherwise, it may be gradual.

Random access points enable, for example, seek, fast forward play, and fast backward play operations in locally stored media streams as well as in media streaming. In contexts involving on-demand streaming, servers can respond to seek requests by transmitting data starting from the random access point that is closest to (and in many cases preceding) the requested destination of the seek operation and/or decoders can start decoding from the random access point that is closest to (and in many cases preceding) the requested destination of the seek operation. Switching between coded streams of different bit-rates is a method that is used commonly in unicast streaming to match the transmitted bitrate to the expected network throughput and to avoid congestion in the network. Switching to another stream is possible at a random access point. Furthermore, random access points enable tuning in to a broadcast or multicast. In addition, a random access point can be coded as a response to a scene cut in the source sequence or as a response to an intra-picture update request.

Some example implementations contemplate the use of media file format standards that include, but are not limited to, ISO base media file format (ISO/IEC 14496-12, which may be abbreviated ISOBMFF), MPEG-4 file format (ISO/IEC 14496-14, also known as the MP4 format), file format for NAL (Network Abstraction Layer) unit structured video (ISO/IEC 14496-15) and 3GPP file format (3GPP TS 26.244, also known as the 3GP format). The ISO base media file format is the base for derivation of all the above mentioned file formats (excluding the ISO base media file format itself).

A method, apparatus and computer program product are provided in accordance with an example embodiment in order to provide 360° video and/or other panoramic content in a manner that maintains computational and bandwidth efficiencies. In this regard, a panoramic image may be generated, at least in part, by automatically presenting high resolution and/or high bitrate content for display within a viewer's viewport or field of view, while presenting content outside that viewport or field of view at a lower resolution and/or bitrate. In some example implementations, rectangular regions or “tiles” are selected within a potential field of view for display at a higher resolution and/or bitrate, decoded separately and merged an output stage for presentation to a viewer.

Virtual reality media content and other media that involves panoramic views (including but not limited to 360° video images and other views) has become increasingly popular with content creators who seek to create an immersive viewing experience and amongst viewers who seek such immersive viewing experiences. In some contexts, panoramic images are used to present a very wide field of view, such as a 360° view or other wide field of view, for example, to a viewer via a specialized viewing device, such as a virtual reality headset and/or other head-mounted display, or another viewing arrangement that is capable of presenting a wide field of view to a viewer.

In some typical situations involving the streaming of virtual reality content, the entirety of a 360° of video is streamed to a viewing device. However, because a human viewer has a limited field of view the user only watches (and is only capable of watching) a portion of the 360° content at any given time. Streaming high quality 360° video (for example, video at high resolution and/or high bitrates) is resource intensive, at least in the sense that streaming and/or otherwise transmitting such high-quality video over a typical communications network can require very high bandwidths and may require the allocation of significant processing resources at a viewing device. Particularly in situations where the entirety of a portion of a 360° video is streamed at high quality (high resolution and high bitrates), the amount of bandwidth and/or other network and/or device resources required to access and consume the 360° virtual reality content may not be practical. Some efforts to at least partially alleviate the strains placed on network resources and/or other resources when streaming 360° and/or other panoramic video content involve breaking the 360° (or other panoramic) video content into overlapping and/or non-overlapping regions. These regions may be referred to herein as “tiles.” Each tile may then be encoded separately and may be further broken into segments that can be delivered over a content delivery network (CDN). Simultaneously or near-simultaneously with the creation and transmission of such tiles and segments, a low resolution base layer of the 360° video may be generated. To display the video content, a compatible player may request the relevant tiles based on a determination of the user's field of view in order to provide the content that is within that field of view at a high resolution, and may use the low-resolution base layer to display the remaining content that falls outside the field of view of the user. In some such implementations, a media presentation description (mpd) is required for the player to discover the tiles and determine which tiles to fetch. Some such approaches may be referred to as viewport dependent delivery (VDD).

It will be appreciated that the implementation of VDD techniques raises a number of technical challenges. Moreover, the effectiveness of VDD and similar techniques in reducing the bandwidth required to provide video at the desired resolutions, and in reducing the latency experienced when switching to high resolution tiles when the user rotates their head and/or otherwise changes their viewport or field of view is highly dependent on the tiling configuration.

As noted herein, the transmission of high-resolution and/or otherwise high-quality, full 360° and/or other panoramic video often requires large amounts of network bandwidth and/or other network resources. Moreover, in situations involving higher-resolutions, the playback and/or other viewing devices receiving such video may not be able to decode and/or render 360° or other panoramic video in the full received resolution, but may instead only be capable of satisfactorily rendering the portion of the video associated with a given viewport in full resolution. Since a viewer is typically only capable of viewing content within one viewport or field of view at a given time, it may be considered to be a waste of bandwidth and decoding resources to transmit full 360 video in contexts involving the streaming of content.

However, selectively providing some content in a higher resolution and other content in a lower resolution raises a number of technical challenges. One such challenge arises when a viewer switches viewports and/or otherwise redirects their view to another region of the panoramic or 360° content. In order to preserve the quality of the viewing experience for the viewer, when switching to a new view (such as a new view within streamed, 360° virtual reality content for example), it is critical that the motion-to-photon latency (which may be measured in terms of the time it takes to view the new content) is minimized. In general, this latency consists of two parts: the time to download new content (such as the higher resolution content to be displayed in a particular region of a 360° video presentation), and the time to tune-in to the new content in the player. The tune-in time is largely dependent on the nature of video compression: if the starting position is not a random access picture, the player may need to decode additional pictures before the target picture.

Some studies of approaches to using VDD in connection with streaming video mainly concentrate on the use of tiles enabled with the HEVC/H.265 video coding standard. Some such approaches also focus on merging tiles from different streams into a single video frame that is fed to the video decoder in a manner similar to that used for a single video. In some such approaches, the tiles are typically presented as a grid of small tiles, which tends to increase tile selection granularity when a viewer moves their head and/or otherwise changes their view.

Some example implementations of the invention described and/or otherwise disclosed herein, involve the use of a full 360° equirectangular base layer, which is independent of the tiles. In some such example implementations, this base layer is configured to feature a lower resolution and bitrate than those that would typically be used when viewing the content, which allows for savings in the use of bandwidth and decoding resources. In some such example implementations, the base layer may be shown to a user as a fallback or backup content supply in case certain tiles are not available in the player. For the material that is located within a viewer's viewport or field of view, some example implementations involve the use of rectangular tiles for an enhancement layer to provide high quality video in the best possible resolution and/or in otherwise high resolution. Some such example implementations further contemplate decoding each tile separately and merging only the output of the decoded tiles, rather than merging the tiles to form a single stream prior to decoding. It will be appreciated that while some of the examples provided herein generally reference a single or mono video, some example implementations of embodiments of the invention described and otherwise disclosed herein may be used with mono, stereo and/or mulit-view videos.

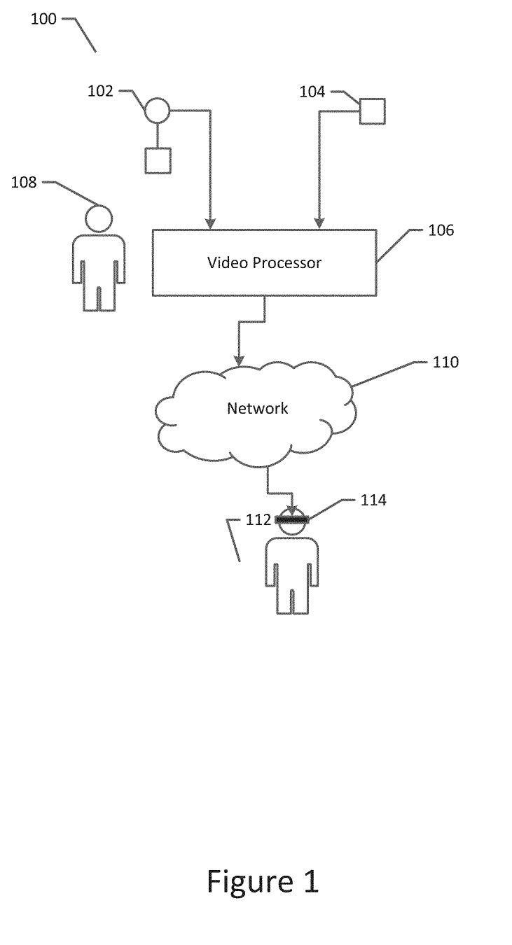

FIG. 1 depicts an example system environment 100 in which implementations in accordance with an example embodiment of the present invention may be performed. The depiction of environment 100 is not intended to limit or otherwise confine the embodiments described and contemplated herein to any particular configuration of elements or systems, nor is it intended to exclude any alternative configurations or systems for the set of configurations and systems that can be used in connection with embodiments of the present invention. Rather, FIG. 1, and the environment 100 disclosed therein is merely presented to provide an example basis and context for the facilitation of some of the features, aspects, and uses of the methods, apparatuses, and computer program products disclosed and contemplated herein. It will be understood that while many of the aspects and components presented in FIG. 1 are shown as discrete, separate elements, other configurations may be used in connection with the methods, apparatuses, and computer programs described herein, including configurations that combine, omit, and/or add aspects and/or components.

As shown in FIG. 1, system environment 100 may include at least one camera 102. Many implementations of system environment 100 contemplate the use of one or more cameras that are suitable for capturing 360° video images for use in the production of virtual reality content. FIG. 1 also contemplates the existence of one or more media sources 104, which may be a database, other device and/or other system which allows for the transmission and/or access of audiovisual content that has been previously captured or otherwise generated.

As shown in FIG. 1, camera 102 and media source 104 are capable of and/or configured to transmit images and/or other audiovisual content, such as 360° video images, as a data stream. Such transmission can be accomplished in accordance with any approach and/or protocol that is suitable for transmitting image data from a camera to one or more devices. In some implementations, transmissions of image data are sent wirelessly or over a wired connection, in real time or near real time, to one or more devices configured to receive and/or process video images.

Some example implementations herein contemplate the use of a viewport, which may or may not coincide with a saliency point or region, such as a point or a region in a 360° image, that may considered to be the most salient point or region within the image to which attention should be directed. Some example implementations herein contemplate the presence within an image of one or more points-of-interest or regions-of-interest, which are considered to be image elements that may be of interest to a content creator and/or one or more viewers. In many situations, the saliency point of an image will be a point-of-interest and respectively the saliency region of an image will be a region-of-interest. Moreover, the saliency point or region of an image may change and/or be changed, such as being changed automatically by a system or system element and/or by an external actor such as a director. In some such situations, the saliency point or region may be switched from one point-of-interest ore region-of-interest, respectively, to another. Consequently some example implementations described herein recognize that viewport and/or a viewer's focus within the image field provided by a 360° video and/or another panoramic video may change over time as a user redirects their view to other points or areas within a video.

As shown in FIG. 1, camera 102 and media source 104 may transmit their respective video image streams to a video processor 106. Video processor 106 is representative of any of a class of devices that may be implemented as stand-alone devices and/or devices that may be integrated into other devices or components. As shown in FIG. 1, video processor 106 is configured to receive the image data streams and any related information from each of camera 102 and media source 104. In some example implementations, video processor 106 is also configured to allow for to identification, development, and/or processing of image tiles, such that regions within a larger field of view may be divided and/or selected in a manner that allows for the transmission of image tiles and/or other regions of an image at a different resolution (typically a higher resolution, for example) than a related base layer video. In some example embodiments, video processor 106 embeds information indicative of information regarding a tile, a saliency point, and/or other information associated with an image into the video stream or a separate stream (or a signaling structure, such as Media Presentation Description) associated with the video stream. In some example embodiments, video processor 106 regards that tile, saliency point, and/or other image information as an indication associated with an intended behavior of a playback device, determines the intended behavior of the playback device, and in response to determining the intended behavior of the playback device, causes a control signal to be generated, wherein the control signal is associated with a rendering operation of the audiovisual presentation on the playback device. Said control signal may for example be included in a video stream or be included in description of a video stream.

Director 108 is shown as an optional operator of video processor 106, and, in some implementations, is capable of monitoring and/or controlling one or more image data streams during the production and/or streaming of the image data streams. In some example embodiments, director 108 causes information indicative of an image tile, saliency point, and/or other image information to be embedded into a particular location in a video stream. In some example embodiments director 108 determines the intended behavior of the playback device and causes a control signal to be generated, wherein the control signal is associated with a rendering operation of the audiovisual presentation on the playback device. Said control signal may for example be included in a video stream or be included in description of a video stream. Director 108 may additionally or alternatively make creative decisions regarding the content presented in a video stream, and the relative arrangement of subjects, background elements, and other objects within the work. As noted above, the director 108 is optional in environment 100, and implementations are possible where information regarding one or more tiles, saliency points, and/or other image aspects are embedded in a video stream by video processor 106, the action of some other device, or otherwise without the presence of or action by a director or other entity.

As depicted in FIG. 1, video processor 106 sends audiovisual content over a network 110. It will be understood that the actual sending apparatus may be a different entity from a video processor entity but that these entities are operationally connected and hence depicted as a single video processor 106. The sending apparatus may for example be an HTTP server (such as a web server, for example) in some embodiments. Network 110 may be any network suitable for the transmission of 360° video and related orientation information, directly and/or indirectly, from one or more devices, such as video processor 106, to a viewing device, such as virtual reality headset 114. While a viewing device is depicted as a single apparatus in FIG. 1, it will be understood that a viewing device may generally comprise several devices that are operationally connected. For example, a virtual reality headset may be connected to a computer that receives the audiovisual content over the network 110. In another example, a virtual reality headset uses as its display device a smartphone that is attached to the headset and receives the audiovisual content over the network 110. In some implementations, the network 110 includes and/or incorporates the public Internet.

FIG. 1 also depicts a user 112, who is associated with a viewing device, such as virtual reality headset 114. In general, virtual reality headset 114 is capable of receiving one or more data streams, such a one or more 360° image data streams (along with the corresponding orientation information), and rendering visible images that can be displayed to the user 112. In some implementations, virtual reality headset 114 is also capable of ascertaining positional information about the user 112, such as the angle and/or degree to which the user 112 has turned his or her head, and other information about the movement of the user 112 or the user 112's head. While FIG. 1 depicts user 112 as viewing content via a virtual reality headset 114, the user may view content via any viewing system that is configured to display all or part of the video transmitted to the user. For example the user may use one or more monitors, mobile device, and/or other handheld or desktop displays to view content. When the display is configured to display part of the 360° content at any single point of time, the user 112 may be given controls which part of the content is displayed. For example, the user 112 may be able to control the viewing direction e.g. using a keyboard, joystick, mouse or any other input peripheral or by rotating or turning the display device, such as a smartphone.

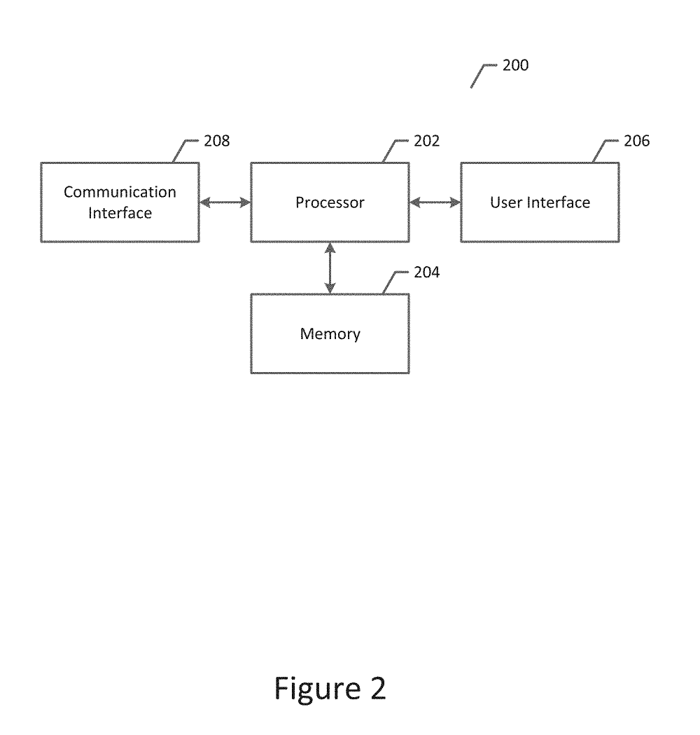

As discussed throughout herein, example embodiments of the invention disclosed and otherwise contemplate herein are directed toward providing for the streaming of high-resolution and/or otherwise high-quality panoramic video images in a manner that more efficiently that may be formed by combining multiple images. Based upon feedback from the viewer (such as a determination of a relevant viewport, viewer orientation, viewer focus, and/or other indication, for example), a panoramic view is generated and combined in accordance with the techniques, approaches, and other developments described herein, including but not limited to the transmission, receipt, and/or rendering of one or more tiles within a 360° and/or other panoramic video at a higher resolution than that used with a base layer of the same video. In this regard, the panoramic view may be generated by an apparatus 200 as depicted in FIG. 2. The apparatus may be embodied by a virtual reality system, such as a head mounted display and/or in equipment used in connection with a head mounted display or other viewer. Alternatively, the apparatus 200 may be embodied by another computing device, external from a viewer. For example, the apparatus may be embodied by a personal computer, a computer workstation, a server or the like, or by any of various mobile computing devices, such as a mobile terminal, e.g., a smartphone, a tablet computer, a video game player, etc. Alternatively, the apparatus may be embodied by any device that may be incorporated into a CDN and/or other communications network.

Regardless of the manner in which the apparatus 200 is embodied, the apparatus of an example embodiment is configured to include or otherwise be in communication with a processor 202 and a memory device 204 and optionally the user interface 206 and/or a communication interface 208. In some embodiments, the processor (and/or co-processors or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

As described above, the apparatus 200 may be embodied by a computing device. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 202 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 202 may be configured to execute instructions stored in the memory device 204 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a pass-through display or a mobile terminal) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

In some embodiments, the apparatus 200 may optionally include a user interface 206 that may, in turn, be in communication with the processor 202 to provide output to the user and, in some embodiments, to receive an indication of a user input. As such, the user interface may include a display and, in some embodiments, may also include a keyboard, a mouse, a joystick, a touch screen, touch areas, soft keys, a microphone, a speaker, or other input/output mechanisms. Alternatively or additionally, the processor may comprise user interface circuitry configured to control at least some functions of one or more user interface elements such as a display and, in some embodiments, a speaker, ringer, microphone and/or the like. The processor and/or user interface circuitry comprising the processor may be configured to control one or more functions of one or more user interface elements through computer program instructions (e.g., software and/or firmware) stored on a memory accessible to the processor (e.g., memory device 204, and/or the like).

The apparatus 200 may optionally also include the communication interface 208. The communication interface may be any means such as a device or circuitry embodied in either hardware or a combination of hardware and software that is configured to receive and/or transmit data from/to a network and/or any other device or module in communication with the apparatus. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

Example embodiments of the invention described and/or otherwise disclosed herein are generally directed to addressing the technical challenges that arise in many virtual reality and other 360° video viewing contexts that involve streaming of 360° and/or other panoramic video content. In some example implementations of such embodiments, a computation-efficient and bandwidth-efficient virtual reality content streaming system may involve the use of a base layer video and one or more enhancement layer videos. Some such example implementations involve a viewport dependent delivery approach, at least in the sense that only the visible part of an enhancement layer (which in some implementations may include some margin) is transmitted and decoded. Stated alternatively, some example implementations contemplate that only the portions of an enhancement layer and/or otherwise higher-resolution version of the video content that appear in a user's viewport (and, in some instances, within a margin around that viewport) are transmitted, decoded, and/or otherwise presented to a viewer.

Some example implementations of embodiments of the invention described and/or otherwise disclosed herein involve the user of a base layer video that covers the entire available field of view for a given video. In some such example implementations, the base layer is independent of any tiles that may be used in connection with providing a higher resolution image for a portion of a video stream. For example, some example implementations involve the use of a full 360° equirectangular base layer video, which is independent of the tiles, but is configured, transmitted, and/or otherwise set with a lower resolution and/or bitrate than those that would normally be used in connection with a high-resolution and/or otherwise high quality video presentation. As a result, some such example implementations are able to reduce the bandwidth and decoding resources necessary to transmit, receive, render, and/or otherwise process streaming video content featuring 360° and/or otherwise panoramic views.

In some example implementations, the base layer (which, as described above, may be transmitted, and/or otherwise configured to with a lower resolution), may be shown as a fallback to address situations in which enhancement layer tiles may not available in a given player. For example, some video players that are not able to process and/or otherwise take advantage of VDD and VDD-type presentations, can use the base layer to play and/or otherwise present the video streams to a viewer. In some such arrangements, as there may be no need to support any other processes other than one or more possible bitrate switching operations in such a stream, the stream containing the base layer may be coded with fewer random access points than the enhancement layer. It will be appreciated that in some alternate approaches, such as where a base layer is encoded as tiles, the base layer segments often need to follow the same coding structure as the enhancement layer tiles, and are therefore forced to also use frequent random access points (which may include, for example, intra frames).

Example embodiments of the invention described and/or otherwise disclosed herein contemplate the use of one or more tiles in an enhancement layer that can be used in conjunction with the larger base layer. In general, the enhancement layer tiles are transmitted and/or otherwise configured to allow the content within the tiles to be displayed at a higher resolution than the resolution level used for the base layer. Particularly in situations where the user's viewport or focus of attention is detectable, it is possible to select the tiles used in connection with the enhancement layer such that the user is always or nearly always presented with content at high resolution, while the remaining content in a 360° or otherwise panoramic view that is outside the user's viewport is available to be viewed at a lower resolution. In some example implementations, rectangular tiles are used for the enhancement layer. In some such example implementations, instead of merging the tiles to form a single stream, each tile is decoded separately and merged only at the output. While some of the example implementations described herein suggest an equirectangular tile configuration, any of a number of projections may be used in connection with example implementations of the tiles, enhancement layer, and other aspects of the invention described and/or otherwise disclosed herein, including but not limited to equirectangular, Lambert, cubemap, equi-angular and/or other projections. Likewise, while some of the examples described herein present a single video for purposes of clarity, example implementations of embodiments of the invention described and/or otherwise disclosed herein may be used in connection with mono, stereo, and/or multi-view videos.

In some example implementations, the layout of the tiles is selected such that the number of tiles that may need to be decoded for a given viewport is minimized and/or otherwise kept small enough to accommodate the potentially limited parallel tile decoding abilities of some of the more common mobile and desktop VR platforms. For example, some mobile devices and other viewers are only capable of decoding a relatively small number of higher-resolution tiles in parallel, and as such, it may be advantageous to keep the number of tiles in the enhancement layer within the practical limits imposed by the viewing device. In some example implementations, it may also be advantageous to configure the tiles such that they are each the same size and/or within a limited set of possible sizes. Doing so may be particularly appropriate in situations where reductions in the efficiency of the players occur when one or more decoders must by reconfigured to accommodate differing tile sizes during tile switching operations.

In some example implementations that involve an equirectangular projection, it is possible to divide the screen or other viewing area, for example, into twelve (12) tiles arranged such that there are six (6) horizontally adjacent tiles arranged in two (2) tile rows. In such an arrangement, when a viewer is looking at the horizon, a player with a 90°×90° viewport may only need to use two (2) or three (3) adjacent tiles on 2 tile rows for the enhancement layer, with a result of overall using four (4)-six (6) tiles.

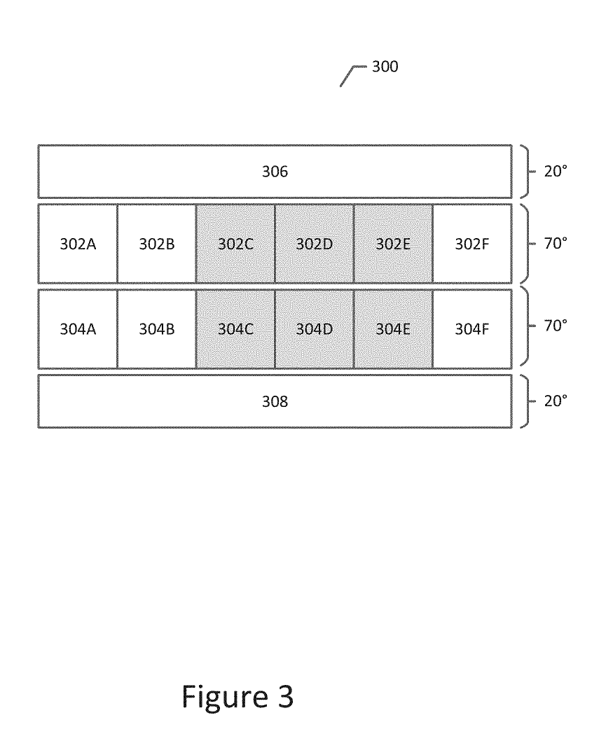

FIG. 3 depicts an example representation of a 360°, equirectangular projection 300 that features four rows 302, 304, 306, 308. In the example depicted in FIG. 3, rows 302 and 304 each have a 70° vertical span, and each of rows 306 and 308 have a 20° vertical span. As shown in FIG. 3, rows 302 and 304 each include six tiles 302a-302f and 304a-304f, respectively. In the example depicted in FIG. 3, each of the tiles 302a-302f and 304a-304f are shown in FIG. 3 as being identically sized, such that each tile has a 60° horizontal span. However, it will be appreciated that other numbers of tiles and/or other configurations of tiles (such as tiles that are substantially the same shape and/or differently shaped, for example) may be used in other example implementations.

In an example implementation involving FIG. 3, and the equirectangular projection 300 shown therein, it may be possible to determine the viewport associated with the viewer at a given time. In such an example implementation, that viewport may be determined to be most closely aligned with the areas covered by tiles 302c-302e and 304c-304e, which are shown in FIG. 3 as shaded. Upon detection of the viewport and/or other relevant viewer orientation, an enhancement layer involving the tiles 302c-302e and 304c-304e may be provided to allow for the presentation of the material contained within those tiles at a higher resolution and/or bitrate than the resolution and/or bitrate used for the content presented in the remaining tiles and/or other regions of the projection.

In some example implementations, it may be advantageous to use two rows. Some situations arise in contexts that involve viewing devices and/or projections such that when a user is looking up or down (from the relevant poles), a 90°×90° viewport covers 360° in longitude but only 45° in latitude from the pole. In such arrangements, the bottom part of the sphere may not be visible and/or otherwise needed, and thus may not need to be presented at a higher resolution. Consequently, it may be advantageous to use more than 2 rows in some such situations. However, the number of parallel decoders needed when looking at the horizon (for example a latitude of 0 degrees) might exceed those available at a relevant viewing device and/or be otherwise impractical.

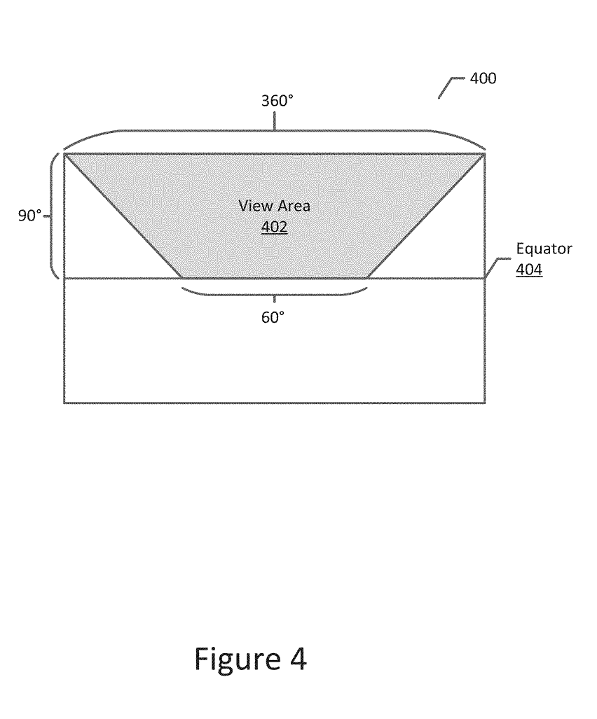

FIG. 4 depicts one such example view 400 that is oriented such that the “north” pole of the projection is at the top, the viewport 402 is that of a user looking up on one side, and the equator 404 is located horizontally in the middle of the projection 400. As shown in FIG. 4, the equator 404 splits the view 400 into two 90° rows. Viewport 402 is shown such that when looking up, the projection provides a 360° field of view at the pole, but only a 60° field of view at the equator.

It will be appreciated that, in some equirectangular projections for example, the poles are effectively stretched. As such, in some example implementations that involve equirectangular projections and/or other projections with stretched pole regions, there might not be any added benefit from the perspective of a view to be derived from sending high resolution tiles over a low resolution base layer to cover the pole regions of an image.

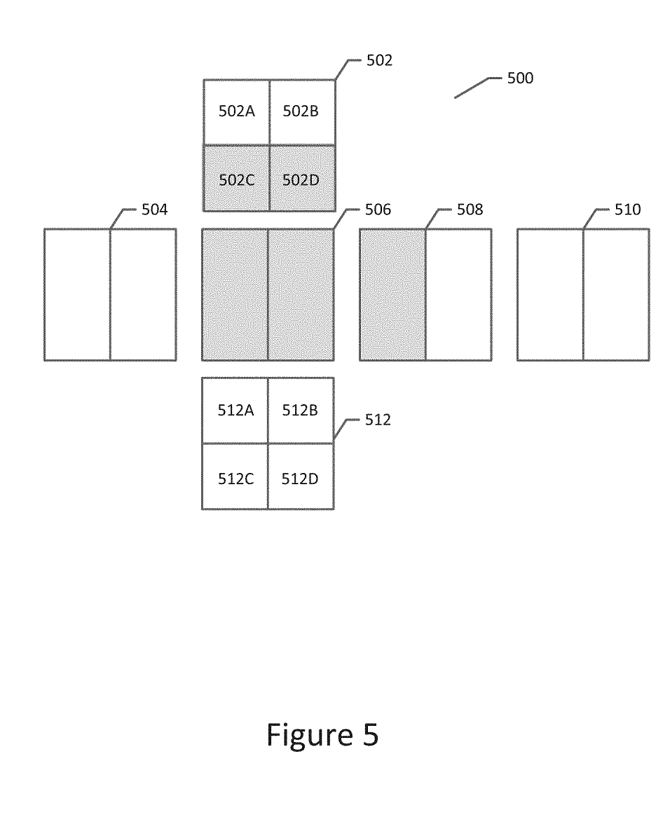

As noted herein, example implementations of embodiments of the invention described and otherwise disclosed herein may be used in a wide variety of projections. FIG. 5 depicts an example view 500 that may be representative of an example implementation of an embodiment of the invention involving a cubemap projection. As shown in FIG. 5, the view 500 is made up of six cube faces 502, 504, 506, 508, 510 and 512, which are depicted as laid open for the purposes of clarity and two-dimensional representation. In some example implementations involving a cubemap projection, such as that shown in FIG. 5, each of the cubemap faces can be divided into tiles. For example, and as shown in FIG. 5, the cubemap faces 504, 506, 508, and 510 are divided such that each cubemap face is divided into two vertically oriented tiles. In the example depicted in FIG. 5, a user may look slightly up and to the right from the horizon and center of the projection. Consequently, the shaded portions of tiles 502, 506, and 508 shown the tiles that may be presented in higher resolution and/or bitrate as part of an enhancement layer. In such an example, the tiles are able to accommodate a 90° viewport of a viewer, regardless of whether the viewport is precisely aligned with a given cubemap face. While the top and bottom cubemap faces 502 and 512 are shown as being divided into four regions 502a-502d and 512a-512d, respectively, an alternative approach may involve transmitting the top and bottom cubemap faces as a single tile each.

As shown in FIG. 5, in some situations, dividing the top and bottom faces 502 and 512 into two tiles in the same way as the other faces may not provide satisfactory results, as the top and bottom may be considered to be rotated by viewing orientation, such that splitting the face into two tiles may result in a situation that is optimal or near optimal in only two out of four directions. To address this situation, some example implementations contemplate dividing the top and bottom faces into 4 tiles, each of which cover about 50% of the face, but are themselves each overlapped by about 50% of the relevant tile area. As shown in the representation presented in FIG. 5, this may cause the faces to appear to be divided into four smaller tiles or regions. However, it will be appreciated that, typically, two such “quarters” will be combined, transmitted, and decoded together to form a tile that is similar in size to the other tiles included in the enhancement layer. For example, if the “quarters” of top and bottom faces 502 and 512 are identified as a to d, one tile may include the area marked as quarters a and b, a second tile may include the area marked as quarters c and d, a third tile may include the area marked as quarters a and c, and a fourth tile may include the area marked as quarters b and d.

Some example implementations of embodiments of the invention are particularly aimed towards attempting to ensure that high resolution and/or otherwise high quality content is presented in the viewport used by a user at any given time. As such, in some example implementations, frequent random access points (which may represented short segments in time, for example) are used with tiles to enable fast switching when a user turns their head or otherwise changes their viewport. Some such example implementations may further involve the use of disposable frames, such as frames that are not used as reference when predicting other frames. In some example implementations involving disposable frames, the disposable frames take the form of B-frames. It will be appreciated that the use of disposable frames may be particularly useful in VDD and approaches similar to VDD, where rendering new tiles as quickly as possible when switching tiles is desirable.

In some example implementations, due to the nature of video compression, the rendering of new tiles may need to start from a random access point. However, it may be impossible and/or impractical to set up video content such that all frames are available as random access points. It will be appreciated that in implementations that allow for temporal scalability to be enabled in a video, it is possible to catch the relevant playhead quickly, such as by fast forwarding to the desired frame from the nearest random access point before the desired frame. In this manner, it may be possible to reduce the number of Intra coded random access points, and hence improve the compression efficiency as compared to approaches that are only based on frequent random access points. As discussed herein, one of the significant technical challenges imposed on efforts to present high resolution and/or high quality video to a viewer in a bandwidth-efficient and processor-efficient manner resides in handling switches by a viewer of their viewport and/or other redirections of a viewer's focus to another region of the relevant panoramic or 360° content. When switching to a new view (such as a new view within streamed, 360° virtual reality content for example), it may be critical from the perspective of preserving the viewing experience that the motion-to-photon latency (which may be measured in terms of the time it takes to view the new content) is minimized. As noted herein, this latency generally consists of two parts: the time to download new content (such as the higher resolution content to be displayed in a particular region of a 360° video presentation), and the time to tune-in to the new content in the player. The tune-in time is largely dependent on the nature of video compression: if the starting position is not a random access picture, the player may need to decode additional pictures before the target picture. Some example implementations of embodiments of the invention herein are able to reduce this latency through the techniques described herein.

By way of example, one example implementation may allow for random access frames to be located at 14 frame intervals. In such an example situation, having a random access frames every 14 frames provides for a GOP size of 14. In such an example, the coding structure of the GOP may be expressed as IPBBBPBBBPBBBP (when using traditional video coding frame types, for example). If it is necessary to fast forward to frame number 9, for example it would be necessary to only decode frames I, P, P, P and B, (for example, 5 frames). As such, the use of disposable B frames allows for the decoding to be completed roughly two times faster than if no disposable B frames were used. Moreover, it will be appreciated that if the relevant tiles in the enhancement layer were merged to other streams, the fast-forward procedure described and contemplated above could not be done in a tile-specific manner, but would instead need more frequent random access points to achieve the same motion-to-photon latency as with the system described herein. It will be appreciated that while the example above references 14 frames and a GOP size of 14 as an example, other implementations may involve the use of other numbers of frames and/or relevant GOP sizes.

As noted herein, some example implementations of embodiments of the invention may involve stereo images. In one such example implementation, one or more stereo video tiles may be encoded in a top-bottom layout, such that the left channel occupies and/or is otherwise associated with the top portion of the video frame, and wherein the right channel occupies and/or is otherwise associated with the bottom portion of the video frame. Some such example implementations may be advantageous in that that they may allow for a reduction in the number of video decoders necessary in a playback device for stereo playback, which may in turn aide in the presentation of such video content in resource-constrained systems. Regardless of whether such example implementations may also result in a reduction of the bandwidth necessary to stream and/or otherwise transport such stereo video or the overall video resolution to be decoded, example implementations involving such a technique may effectively reduce the potential overhead associated with using a relatively large number of parallel decoder instances and may also reduce the overhead included with processing any parallel downloaded streams from a relevant server.

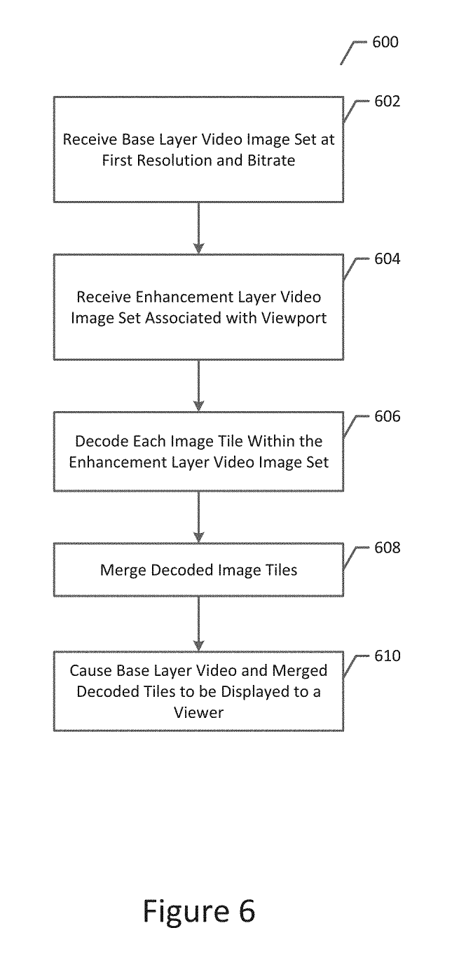

Referring now to FIG. 6, the operations performed by the apparatus 200 of FIG. 2 in accordance with an example embodiment of the present invention are depicted as a process flow 600. In this regard, the apparatus includes means, such as the processor 202, the memory 204, the user interface 206, the communication interface 208 or the like, for providing 360° video and/or other panoramic content in a manner that maintains computational and bandwidth efficiencies. In this regard, a panoramic image may be generated, at least in part, by automatically presenting high resolution and/or high bitrate content for display within a viewer's viewport or field of view, while presenting content outside that viewport or field of view at a lower resolution and/or bitrate.

As shown in FIG. 6, the apparatus includes means, such as the processor 202, the memory 204, the user interface 206, the communication interface 208 or the like, for receiving a base layer video image set, wherein the base layer video image set is associated with a first resolution and a first bitrate. For example, and with reference to block 602 of FIG. 6, the apparatus 200 of an example embodiment may receive a base layer video image set at a first resolution and bitrate. As discussed herein, example implementations of embodiments of the invention often arise in circumstances involving streaming video that is designed to provide 360° and/or otherwise panoramic views, such that the video images present content in a wider field of view than that which a human viewer is capable of viewing at one point in time. As such, some example implementations contemplate using a relatively low resolution and/or bitrate with the base layer video image set, in order to reduce the demand on network and/or other processing resources necessary to stream, receive, process, render, and/or otherwise display the video content to a viewer. Any approach to receiving the base layer video image set may be used in connection with example implementations of block 502, and it will be appreciated that the approach which may be most appropriate in a given situation may be based at least in part on the capabilities of the viewing device and/or any network with which such viewing device may interact. In some example implementations, a viewing device, such as a head-mounted display and/or a mobile device may interact with a CDN and/or other data network in order to receive the base layer video image set and/or any other content associated with process 500 and/or any implementation of the invention.

In some example implementations of process 600 in general and block 602 in particular, the base layer video image set is a 360° equirectangular base layer video. In some such example implementations, the base layer video image set is independent of any plurality of tiles that may be used in connection with an enhancement layer of a related set of video images.

The apparatus also includes means, such as the processor 202, the memory 204, the user interface 206, the communication interface 208 or the like, for receiving a first enhancement layer video image set, wherein the first enhancement layer video image set is associated with a second resolution and a second bit rate, and wherein the first enhancement layer video image set comprises a plurality of image tiles, wherein each image tile within the plurality of image tiles is associated with a viewport of a user. For example, and with reference to block 604 of FIG. 6, the apparatus 200 of an example embodiment may receive an enhancement layer video image set associated with a viewport of a user. As described herein, example implementations of embodiments of the invention contemplate the use one or more image tiles in an enhancement layer to provide high resolution and/or otherwise high quality video images to a viewer in the viewport used by a user at a given time, with the aim of limiting the bandwidth and/or other system resources necessary to provide a quality viewing experience to a user. As described herein, upon detecting a viewport associated with the user, one or more tiles that cover the area of the viewport (and, in some examples, regions adjacent to the viewport) can be requested and/or otherwise provided to an apparatus. In some example implementations, the resolution and/or bitrate used with such image tiles is higher than the resolution and/or bitrate used with the base layer.

As discussed herein, example implementations of the invention in general, and the use of tiles in an enhancement layer in particular, may involve a range of projection protocols, including but not limited to an equirectangular projection, a Lambert projection, and/or a cubemap projection. In some such example implementations, and in other example implementations, each of the image tiles received by the apparatus may be the same shape and/or substantially the same shape.

The apparatus also includes means, such as the processor 202, the memory 204, the user interface 206, the communication interface 208 or the like, for decoding each image tile from within the plurality of tiles to form a plurality of decoded image tiles. For example, and with reference to block 606 of FIG. 6, the apparatus 200 of an example embodiment may decode each image tile within the enhancement layer video image set. As described and otherwise contemplated herein, example implementations of embodiments of the invention contemplate the use of parallel image processing to rapidly decode the tiles, such that a latency or delay associated with providing the high resolution images received as part of the enhancement layer image tiles may be reduced. Any approach to decoding the received images may be used, and the precise protocols used to decode the image tiles will typically depend, at least to some degree, on the file formats and/or transmission protocols used in connection with compressing, transmitting, and/or otherwise providing the video images to a viewing device.

The apparatus also includes means, such as the processor 202, the memory 204, the user interface 206, the communication interface 208 or the like, for merging the decoded image tiles. For example, and with reference to block 608 of FIG. 6, the apparatus 200 of an example embodiment may merge the decoded image tiles. Any approach to merging image tiles may be used in connection with example implementations of block 608. For example, in some example implementations, each of the enhancement layer tiles are decoded separately and merged only at their output.

The apparatus also includes means, such as the processor 202, the memory 204, the user interface 206, the communication interface 208 or the like, for causing the base layer video image set and the merged decoded image tiles to be displayed to a viewer. For example, and with reference to block 610 of FIG. 6, the apparatus 200 of an example embodiment may cause the base layer video and the merged decoded tiles to be displayed to a viewer. As discussed herein, example embodiments of the invention disclosed and otherwise contemplated herein involve the use of a base layer video at one resolution and/or bitrate and tiles that are at a higher resolution and/or bitrate as part of an enhancement layer in order to provide higher quality video images in the region of a 360° or otherwise panoramic video that a user is viewing at any given time. As such, some example implementations of block 610 contemplate causing video images to be displayed to a user via a viewing device, such as a head-mounted display, a mobile device, and/or another viewing setup. Upon detecting a viewport associated with the viewer, tiles associated with that viewport may be selected, decoded, merged, and otherwise presented to a viewer in connection with the base layer, which provides images for the regions of the video that are outside of the viewport.

It will be appreciated that the location of the viewport, and thus the selection of the tiles for inclusion in an enhancement layer, may not be static. As such, the apparatus may also be capable of detecting a change in a viewport associated with a viewer (for example, by detecting a shift in the viewer's head position, eye direction, viewing position, and/or other indicator of the viewport). Upon detecting a change in the viewport, the apparatus may then request a second enhancement layer video image set, which may include, for example, tiles that are associated with the area of the new viewport.

It will be appreciated that example embodiments of the invention described and/or otherwise disclosed herein may present a number of advantages over conventional video streaming approaches. For example, the base layer referenced herein may be structured and/or otherwise configured to be compatible with a broad range of viewing devices, including but not limited to viewing devices that are not typically associated with VR and/or otherwise immersive content, such as mobile devices, other portable players, and the like. As such, depending on the configuration of the base layer, users across a wide range of devices may be able to receive and view 360° and/or otherwise panoramic content without necessarily exceeding practical bandwidth and/or processing limits. In some example implementations, the base layer may be encoded with a lower number access point interval than the enhancement layer, which may in turn allow of the base layer to be more effectively compressed for streaming, other transmission and/or other processing.

It will also be appreciated that in some example implementations, allow for improved latency when switching between and/or amongst enhancement layer tiles by utilizing temporal scalability when catching up the playhead after tile switching. This in turn may reduce the necessary random access point (Intra frame) interval and provide a noticeable compression efficiency gain. Moreover in some example implementations that allow for parallel decoding of a base layer and an enhancement layer, the enhancement layer can use a different projection than the base layer. For example, the base layer may be an equirectangular panorama, while the enhancement layer can use, for example, a cubemap projection.

As described above, FIG. 6 illustrates a flowchart of an apparatus 200, method, and computer program product according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by the memory device 204 of an apparatus employing an embodiment of the present invention and executed by the processor 202 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving a base layer video image set, wherein the base layer video image set is associated with a first resolution and a first bitrate;
receiving a first enhancement layer video image set, wherein the first enhancement layer video image set is associated with a second resolution and a second bit rate, and wherein the first enhancement layer video image set comprises a plurality of image tiles associated with a viewport of a user;
decoding a set of image tiles from within the plurality of image tiles to form a plurality of decoded image tiles;
merging the decoded image tiles; and
causing the base layer video image set and the merged decoded image tiles to be displayed to a viewer.

2. The method of claim 1, wherein the base layer video image set is a 360° equirectangular base layer video.

3. The method of claim 2, wherein the base layer video image set is independent of the plurality of image tiles.

4. The method of claim 1, wherein the second resolution is higher than the first resolution.

5. The method of claim 1, wherein the second bitrate is higher than the first bitrate.

6. The method of claim 1, wherein two or more image tiles within the plurality of image tiles are substantially the same shape.

7. The method of claim 1, wherein an image tile within the plurality of image tiles is configured to be used in an equirectangular projection.

8. The method of claim 1, wherein an image tile within the plurality of image tiles is configured to be used in a Lambert projection.

9. The method of claim 1, wherein an image tile within the plurality of image tiles is configured to be used in a cubemap projection.

10. The method of claim 1, wherein causing the base layer video image set and the merged decoded image tiles to be displayed to a viewer comprises causing the base layer video image set and the merged decoded image tiles to be displayed on a mobile device associated with user.

11. The method of claim 1, further comprising detecting a change in a viewport associated with a viewer and requesting a second enhancement layer video image set.

12. An apparatus comprising at least one processor and at least one memory storing computer program code, the at least one memory and the computer program code configured to, with the processor, cause the apparatus to at least:
receive a base layer video image set, wherein the base layer video image set is associated with a first resolution and a first bitrate;
receive a first enhancement layer video image set, wherein the first enhancement layer video image set is associated with a second resolution and a second bit rate, and wherein the first enhancement layer video image set comprises a plurality of image tiles associated with a viewport of a user;
decode a set of image tiles from within the plurality of image tiles to form a plurality of decoded image tiles;
merge the decoded image tiles; and
cause the base layer video image set and the merged decoded image tiles to be displayed to a viewer.

13. The apparatus of claim 12, wherein the base layer video image set is a 360° equirectangular base layer video.

14. The apparatus of claim 13, wherein the base layer video image set is independent of the plurality of image tiles.

15. The apparatus of claim 12, wherein the second resolution is higher than the first resolution.

16. The apparatus of claim 12, wherein the second bitrate is higher than the first bitrate.

17. The apparatus of claim 12, wherein two or more image tiles within the plurality of image tiles are substantially the same shape.

18. The apparatus of claim 12, wherein an image tile within the plurality of image tiles is configured to be used in an equirectangular projection.

19. The apparatus of claim 12, wherein an image tile within the plurality of image tiles is configured to be used in a Lambert projection.

20. The apparatus of claim 12, wherein an image tile within the plurality of image tiles is configured to be used in a cubemap projection.

21. The apparatus of claim 12, wherein causing the base layer video image set and the merged decoded image tiles to be displayed to a viewer comprises causing the base layer video image set and the merged decoded image tiles to be displayed on a mobile device associated with user.

22. The apparatus of claim 12, the at least one memory and the computer program code further configured to, with the processor, cause the apparatus to at least further:
detect a change in a viewport associated with a viewer and request a second enhancement layer video image set.

23. A computer program product comprising at least one non-transitory computer-readable storage medium having computer-executable program code instruction stored therein, the computer-executable program code instructions comprising program code instructions configured to:
receive a base layer video image set, wherein the base layer video image set is associated with a first resolution and a first bitrate;
receive a first enhancement layer video image set, wherein the first enhancement layer video image set is associated with a second resolution and a second bit rate, and wherein the first enhancement layer video image set comprises a plurality of image tiles associated with a viewport of a user;
decode a set of image tiles from within the plurality of image tiles to form a plurality of decoded image tiles;
merge the decoded image tiles; and
cause the base layer video image set and the merged decoded image tiles to be displayed to a viewer.
